(19) United States
(12) Patent Application Publication
(10) Pub. No.: US 2009/0019032 A1
(43) Pub. Date: Jan. 15, 2009

(54) Method and a system for semantic relation extraction

(75) Inventors: Markus Bundschus, Munich (DE); Mathaeus Dejori, Munich (DE); Martin Stetter, Munich (DE); Volker Tresp, Munich (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munich (DE)

(21) Appl. No.: 11/979,534

(22) Filed: Nov. 5, 2007

(30) Foreign Application Priority Data
Jul. 13, 2007 (EP) EP07013828

(51) Int. Cl. G06F 17/30

(52) U.S. Cl. 707/5; 707/E17.014

(57) ABSTRACT

The invention provides a method for semantic relation extraction, wherein on the basis of an annotated training corpus having tokens with associated relational labels each indicating a relation between the respective token and a selectable key entity semantic relation between said key entity and other entities are directly extracted from unstructured text using a probabilistic extraction model.

### BACKGROUND OF THE INVENTION

The invention relates to a method and a system for semantic relation extraction in particular from biomedical data.

The rapid growth of published literature in many fields of technology such as the biomedical domain renders automated information extraction tools indispensable for researchers to make use of this immense source of knowledge.

The past decade has been undergone an unprecedented increase of biomedical data in published literature. Progress in computational and biomedical methods has increased the pace of biomedical research. High throughput experiments, such as micro-arrays, produce large quantities of high-quality data which consequently leads to an increase of new findings and results. This development has caused an explosion of scientific literature published in this technical field. The overwhelming amount of textual information makes it necessary to use automated text information extraction tools to efficiently use the enormous amount of knowledge contained in biomedical literature stored in data bases. Text mining applications are provided to transfer unstructured information such as unstructured text information into structured form. Some text mining applications can only identify named entities. Possible entities in the biomedical field are genes, diseases, drugs, compounds, proteins etc. More important than identifying entities in an unstructured information data base is the identification of associations and relations between these entities. Relation extraction (RE) is the finding of associations and roles between entities having an unstructured information base such as text phrases. These text phrases are usually but not necessarily formed by a sentence.

The conventional semantic relation extraction methods comprise two consecutive steps. In a first step the entities are identified by means of a named entity recognition (NER). In a second step for each pair of entities a relation type is predicted.

FIG. 1 shows a flow-chart for explaining a conventional method for semantic relation extraction. In a preprocessing phase features for evaluating text information are defined and an annotated training corpus is generated. The features for evaluating the unstructured text information can be predefined character strings being typical for a certain entity, such as “CADH”. Another example for a feature might be whether a number can be found in the text. In the preprocessing phase an annotated training corpus is generated by experts in the respective technical field. The training corpus can be formed by sentences annotated by the experts.

FIG. 2 shows a table as an example for an annotated training corpus used by a conventional extraction method according to the state of the art. In the given example the training corpus consists of only two sentences i.e. “we found that TP53 is a lung cancer gene” and “smoking is bad for your lungs”. In real systems, the training corpus consists of a plurality of sentences or a plurality of documents or abstracts. Both sentences of the annotated training corpus consist of several words and tokens which are labeled by the experts according to a predefined classification scheme. It can be seen from FIG. 2 that most tokens of the annotated training corpus are labeled to be common words (C). However, some tokens such as “TP53”, “lung” and “cancer” are labeled differently. The token “TP53” is labeled to be a “gene”. The neighboring tokens “lung” and “cancer” are both labeled as a disease d. Note that in the table of FIG. 2 the word “lung” in the context of sentence 1 is labeled to be a disease d because the next word is “cancer”, whereas “lungs” in the other sentence 2 of the training corpus is labeled to be a common word c.

After the feature definition and the generation of the annotated training corpus in the preprocessing phase, a feature set is provided for the annotated training corpus and weights are calculated on the basis of a feature label distribution in a training phase.

In a further step an input query is input by a user to extract a semantic relation. A possible example is the sentence “Inactivating TP53 mutations were found in 55% of lethal metastatic pancreatic neoplasms”. The input query is tokenized into a sequence of tokens.

The table of FIG. 3 shows a token sequence consisting of twelve tokens x1 to x12 generated on the basis of the query input by the user. It can be seen from the flowchart of FIG. 1 that in a conventional method for semantic relation extraction entity detection is performed after tokenization of the query. By means of a Viterbi algorithm the most likely label sequence is calculated. FIG. 3 shows the most likely label sequence for the given example. In the given example two entities are detected, i.e. one gene G and one disease D. Please note that the labels Y9, Y10, Y11, Y12 are recognized to represent one disease D.

After completion of the entity detection a second step for relation extraction is performed in the conventional method as shown in the flow-chart of FIG. 1. The relation extraction is for example rule-based.

FIG. 4 shows a rule-based relation extraction performed by the conventional method. A possible way for a rule-based relation extraction according to the state of the art as shown in FIG. 4 is for the algorithm to check whether the tokens xᵢ, which are labeled as common words c include keywords which are indicative for a corresponding relation. In the given example the token x3 “mutations” forms a common word c, but the token “mutations” is also an indicator for a particular relation, i.e. in this case genetic variation. After the rule-based relation extraction, the extracted relation is indicated to the user as shown in FIG. 5. The user is informed that there is a relation “genetic variation” between the primary entity “gene TP53” and a second entity, i.e. a disease “lethal metastatic pancreatic neoplasms”.

As can be seen from the given example, relation extraction in conventional methods performed in a two-step manner, i.e. first the participating entities are identified and then the relations between the entities are extracted. Both pairs of entities are enumerated for a given text phrase and for each pair a prediction is made whether there is a relation or not.

However, this conventional method for relation extraction as shown in the flow-chart of FIG. 1 has several disadvantages. During calculation of the most likely label sequence by means of a Viterbi algorithm it can occur that the extracted entities are not labeled correctly. The conventional method is very sensitive to errors made during a named entity recognition (NER). A disease mislabeled as another entity in the NER-phase cannot be taken into account in a gene disease relation classification phase. As another example for instance if tokens X9 to X12 shown as in table FIG. 3, i.e. “lethal”, “metastatic”, “pancreatic”, “neoplasms” are mislabeled as genes (G) following a rule-based relation extraction the error is carried along so that the user receives as an output a genetic variation relation between a gene TP53 and a gene “lethal metastatic pancreatic neoplasms”. A further possible disadvantage of the conventional method for extracting relations is that for training one needs to process all pairs of entities within sentences which results in a lower number of positive examples and, thus, lower accuracy.

It is an object of the present invention to provide a method and a system for overcoming the disadvantages of the conventional method for semantic relation extraction as shown in FIG. 1.

### BRIEF SUMMARY OF THE INVENTION

The invention provides a method and a system for semantic relation extraction on the basis of an annotated training corpus having tokens with associated relation labels each indicating a relation between the respective token and a selectable key entity wherein semantic relations between the key entity and other entities are directly extracted from unstructured text using a probabilistic extraction model.

In an embodiment of the system according to the present invention the probabilistic extraction model is a conditional random field (CRF).

### BRIEF DESCRIPTION OF THE FIGURES

FIG. 1 shows a flow-chart of a conventional method for semantic relation extraction according to the state of the art;

FIG. 2 shows a table of an example for an annotated training corpus as used by the conventional method for semantic relation extraction shown in the flow-chart of FIG. 1;

FIG. 3 is a table of a calculated most likely label sequence of a tokenized input query as an intermediate result of the conventional method for semantic relation extraction shown in the flow-chart of FIG. 1;

FIG. 4 illustrates a rule-based relation extraction step as employed by a conventional method for semantic relation extraction as shown in the flow-chart of FIG. 1;

FIG. 5 shows the output of a conventional method for semantic relation extraction according to the state of the art for the exemplary input query of FIG. 3 and the exemplary annotated training corpus indicated in FIG. 2;

FIG. 6 shows a block diagram of a possible embodiment of a system for semantic relation extraction according to the present invention;

FIG. 7 shows a flow-chart of a possible embodiment of the method for semantic relation extraction according to the present invention;

FIG. 8 shows a simple flow-chart illustrating the calculation of weighting factors as employed by an embodiment of the method for semantic relation extraction according to the present invention;

FIG. 9 shows a simple flow-chart illustrating the tokenization of an input query as employed by an embodiment of the method for semantic relation extraction according to the present invention;

FIG. 10 shows a simple flow-chart indicating the extraction of relations of a key entity as employed by an embodiment of the method for semantic relation extraction according to the present invention;

FIG. 11 shows an example of an annotated training corpus and a query for illustrating the functionality of an embodiment of the method for semantic relation extraction according to the present invention;

FIG. 12 shows a table illustrating the functionality of a method and a system for semantic relation extraction according to the present invention;

FIG. 13 shows a table indicating a calculated most-likely label sequence for a tokenized exemplary query as shown in FIG. 11;

FIG. 14 shows an exemplary output of a result of the method for semantic relation extraction according to an embodiment of the present invention for the given example of FIG. 11.

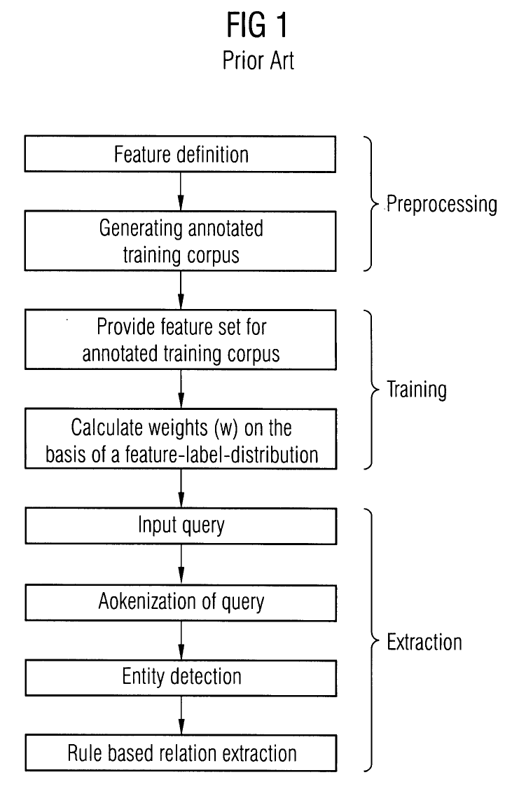

### DETAILED DESCRIPTION OF THE INVENTION

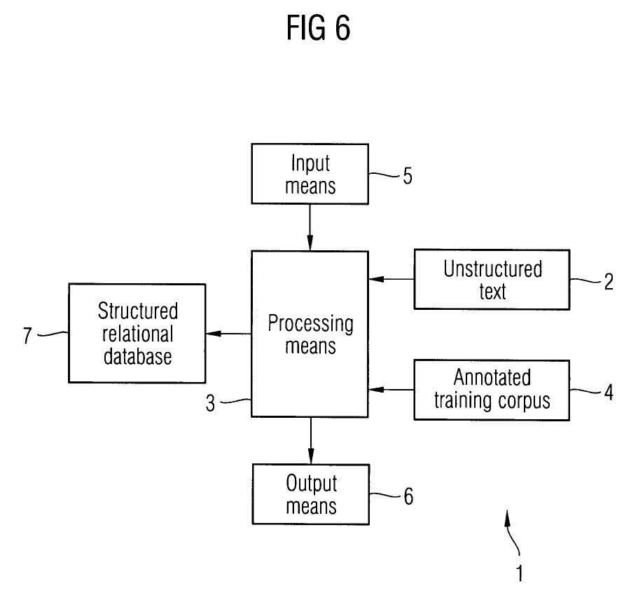

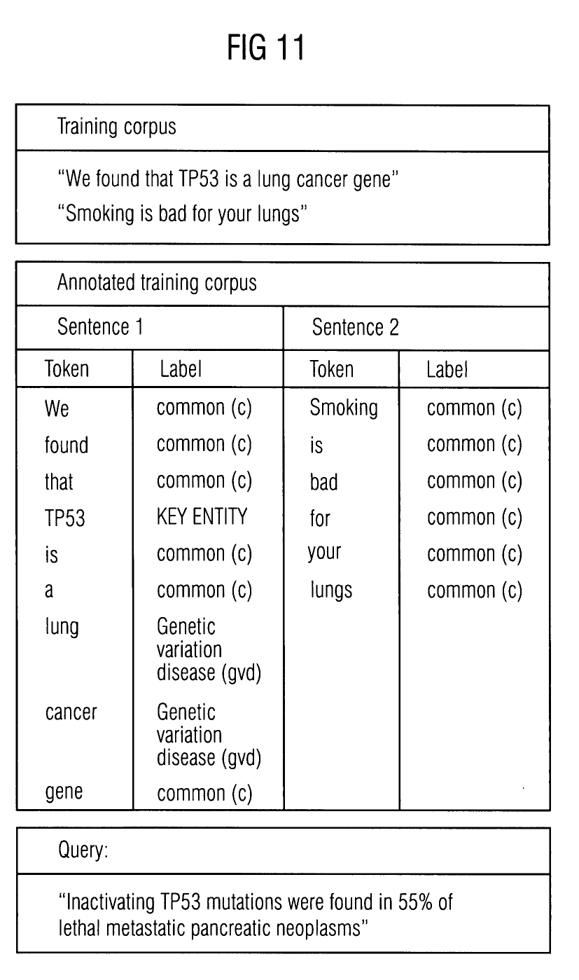

FIG. 6 shows a block diagram of a possible embodiment of a semantic relation extraction system 1. It can be seen from FIG. 6 that unstructured text comprising-a plurality of documents is stored in a data base 2. The data base 2 is connected to processing means 3. The data base 2 is connected either directly or via a network to the processing means 3. In other embodiments the processing means 3 are connected to a plurality of different data bases each having a plurality of unstructured documents. In a memory 4, an annotated training corpus is stored. The annotated training corpus comprises a plurality of tokens each having an associated relational label indicating a relation between the respective token and a selectable key entity. An example for an annotated training corpus used by the system according to the present invention is shown in FIG. 11. The processing means 3 can be formed by any processor. The processing means 3 is connected to input means 5 and output means 6. The user can input a query, for instance an input query sentence by means of the input means 5. For example the input means 5 can be formed by a keyboard. The output means 6 can be formed by a display 6. The processing means 3 extracts semantic relations between a key entity and other entities from the unstructured text in the data base 2 on the basis of the annotated training corpus stored in the memory 4. Semantic relations extracted by the processing means 3 can be stored by the processing means 3 in a structured relational database 7.

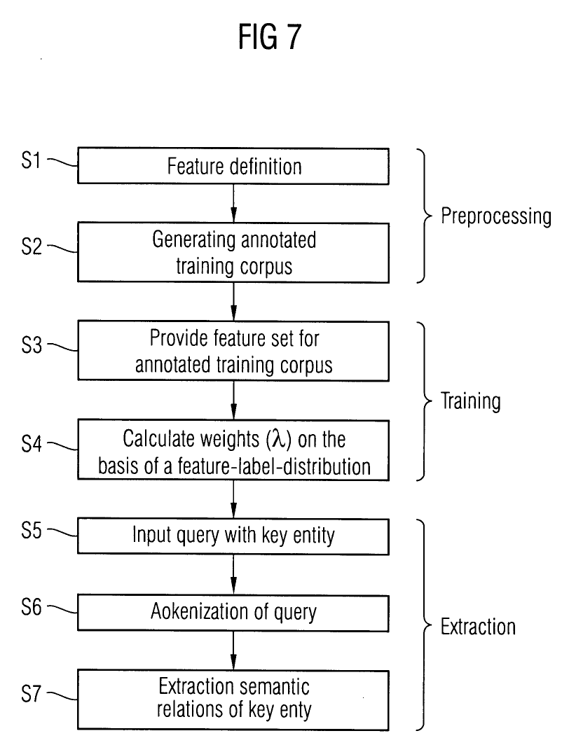

FIG. 7 shows a flow-chart of a possible embodiment of the method for semantic relation extraction according to the present invention.

In a preprocessing phase a feature definition is performed in step S1 and the training corpus is generated in step S2. An example for an annotated training corpus generated in step S2 is shown in FIG. 11.

During a training phase consisting of step S3, S4 as shown in FIG. 7 a feature set for the annotated training corpus is provided and weights are calculated on the basis of a feature-label-distribution.

The features used by the method according to the present invention comprise a set of standard condition features and additional relation recognition features. The standard recognition features can comprise orthographic feature, work shape features, n-gram features, dictionary features or context features.

The biomedical entities often yield some orthographic characteristics. In many cases, biomedical entities consist of capitalized letters, include some numbers or are composed of combinations of both. Accordingly, orthographic features can help to distinguish various types of biomedical entities. Another recognition feature is a word shape feature.

Some words belonging to the same class of entities have the same word shape. For instance, for disease abbreviations it is common that no number plus normal letters appear in the token as for gene/protein co-occurrence of numbers and letters is typical.

As a further recognition feature according to the method according to the present invention uses character n-gram features for 2≦n≦4. This recognition feature helps to recognize informative sub-strikings like “ASE” or “HOMEO”, especially for words not seen in training.

A further group of recognition features are dictionary features. For example, a disease dictionary can be used and is constructed by taking all names and synonyms of concepts covered by the disease branch (C) of the MeSH ontology. Furthermore, as a possible embodiment keyword dictionaries are used for different relation types such as altered expression, genetic variation, regulatory modification and unrelated. For example, a genetic variation dictionary can contain words like “mutation” and “polymorphism”. A dictionary feature is on, if the token matches with at least one keyword in the corresponding dictionary. Note that the presence of a certain keyword in a sentence is indicative, but not imperative for a specific relation. This is handled by the method according to the present invention because of its probabilistic nature.

A further group of recognition features are context features. These context features consider the properties of preceding or following tokens for a current token xᵢ in order to determine its category. Context features are important for several reasons. Thus, in case of nested entities such as: “breast cancer 2 protein is expressed . . . ”. In this text phrase one does not want to extract a disease entity. Thus, when determining the correct label y for the token “breast”, it is important that one of the preceding word features will be “protein” indicating that “breast” refers to gene/protein entity and not to a disease. In a possible embodiment a window size is set to three. Context features are not only important in case of nested entities but also for relation extraction.

In the method and system according to the present invention besides the recognition features further relation recognition features are provided. These additional relation recognition features comprise for example a dictionary window feature, a key entity neighborhood feature, a start window feature and a negation feature.

Each of the relation type dictionaries, for example for the relation type dictionaries mentioned above, i.e. the altered expression dictionary, the genetic variation dictionary, the regulatory modification dictionary and the unrelated dictionary it is defined that a feature is on, if at least keyword from the corresponding dictionary matches a word in a window size of N, i.e.

$$- \frac{N}{2} and + \frac{N}{2}$$

tokens away from the current token. In an embodiment N=20.

Furthermore, as a key entity neighborhood feature for each of the relation type dictionaries a feature is defined to be on if at least one keyword matches a word in a window size of M, i.e.

$$- \frac{M}{2} and + \frac{M}{2}$$

tokens away from the key entity token. In a possible embodiment M=6.

As a start window feature for each of the relation type dictionaries it is defined that the feature is on if at least one keyword matches a word in the first L tokens of a sentence. In a possible embodiment L=3. With this feature the fact is addressed that for many sentences important properties of a gene-disease-relation are mentioned at the beginning of a sentence.

A negation feature is defined such that this feature is on, if none of the three above-mentioned relation recognition features matches a dictionary keyword.

In an embodiment relation type features are based solely on dictionary information. In alternative embodiments, further information is integrated as relation type features such as word shape or n-gram features.

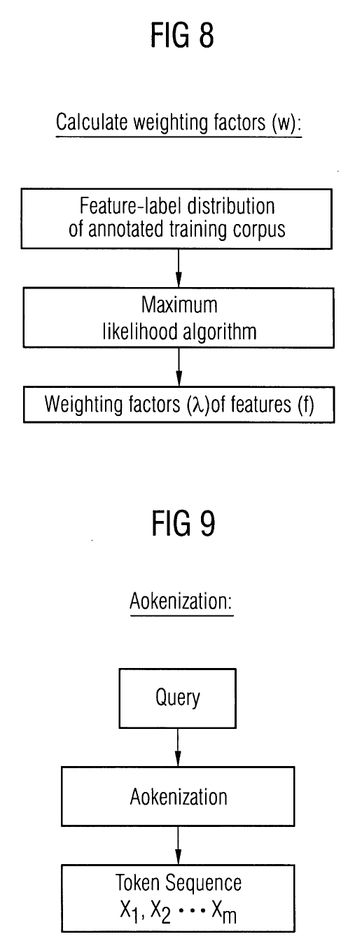

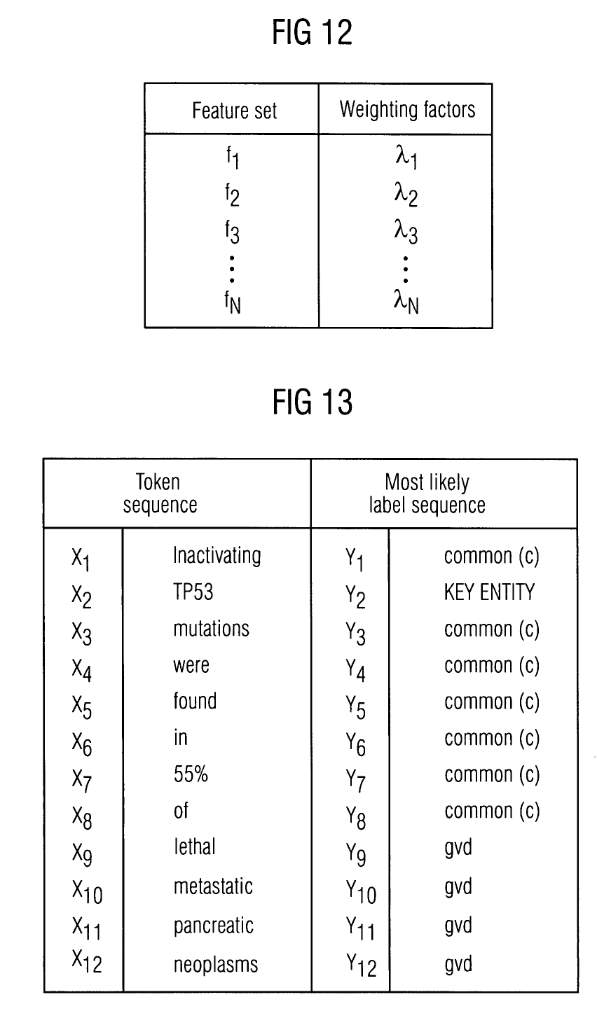

In step S3 of the flow-chart of FIG. 7 a feature a set of different features is provided for the annotated training corpus. For each feature of the feature set a corresponding weight λ is calculated by means of a maximum likelihood algorithm on the basis of a feature label distribution as shown in the flow-chart of FIG. 8. Accordingly, for each feature f a corresponding weighting factor λ is calculated as shown in the table of FIG. 12. A conditional random field CRF is defined as an undirected graphical model represented by a graph with vertices representing random variables and edges representing conditional independence assumptions. The most common graph is a graph which obeys a first order Markov property for each random variable yᵢ. This means that each label variable y₁ and yᵢ₊₁ are associated in the graph G. Then y is said to be a linear chain CRF.

A conditional probability p of a label or state sequence for a given input sequence is defined as:

$$p ( y / x ) = \frac{1}{{Z}_{x}} exp ( {\sum }_{i = 1}^{N} {\sum }_{k = 1}^{K} {λ}_{k} {f}_{k} ( {y}_{i - 1} , {y}_{i} , x , i )$$

wherein Zₓ is a normalization factor, fₖ(yᵢ₋₁, yᵢ, x, i) is an arbitrary feature function and λ_{K} is a calculated weight for a feature function ranging between −∞ and +∞.

Each feature function fᵢ specifies an association between a token x at a certain position and a label y for that position. Therefore, with each feature f one can express some characteristics of an empirical distribution of training data that should also be true for a model distribution.

The corresponding feature weight λk specifies whether the association should be favored or disfavored. Higher values of λ indicate that their corresponding label transitions are more likely. In general, a weight λ for each feature f is high if the feature f tends to be on for the correct labeling. The weight λ is negative if the feature tends to be off for the correct labeling and should be around zero if it is uninformative. The weights λ are learned in a possible embodiment from labeled training data of the training corpus by a maximum likelihood estimation (MLE) algorithm.

The normalization factor Zₓ is the sum over all possible state or label sequences S^{N}, while N is the length of the input sequence:

$${Z}_{x} = {\sum }_{s ∈ {S}^{N}} exp ( {\sum }_{i = 1}^{N} {\sum }_{k = 1}^{K} {λ}_{k} {f}_{k} ( {y}_{i - 1} , {y}_{i} , x , i )$$

After the training phase the user can input a query via the keyboard 5 to perform a semantic relation extraction in the extraction phase as shown in FIG. 7. In a step S5 the user inputs the query Q. The query Q can consist of a sentence, i.e. a sequence of words. The query Q comprises a key entity. As can be seen from the example in FIG. 11, the annotated training corpus employed by the method and system according to the present invention has a token labeled by the expert as key entities. As can be seen from the example in FIG. 11, token “TP53” is labeled as a key entity. The user inputs for example a query Q such as “inactivating TP53 mutations were found in 55% of lethal metastatic pancreatic neoplasms” in step S5.

In a further step S6 the query Q is tokenized, i.e. a token sequence x₁, x₂, . . . xₘ is generated as illustrated by FIG. 9. FIG. 13 shows a table with the generated token sequence consisting of twelve tokens x₁ to x₁₂ for the given query example.

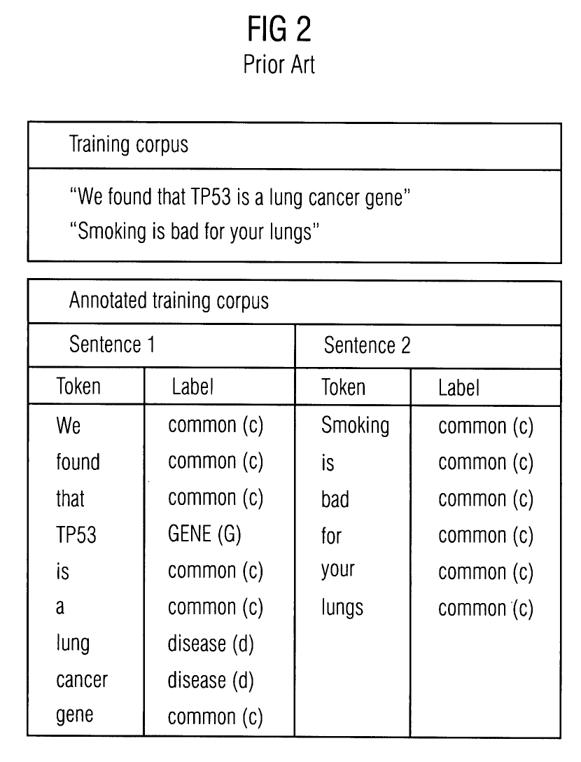

As can be seen from the table in FIG. 11 in the annotated training corpus as used by the method according to the present invention, some tokens x such as “lung” and “cancer” are labeled with a relation such as “genetic variation disease GVD”. By comparing the annotated training corpus as used by the method according to the present invention as shown in FIG. 11 with the annotated training corpus used by the conventional method for semantic relation as shown in FIG. 2 it becomes evident that some tokens x such as “lung” or “cancer” in the annotated training corpus according to the present invention are not only labeled as a disease d but a relation of this token x to the key entity KE is also encoded or labeled. In the given example the encoded relation of the tokens “lung” and “cancer” to the key entity, i.e. TP53, is “genetic variation disease” (GVD).

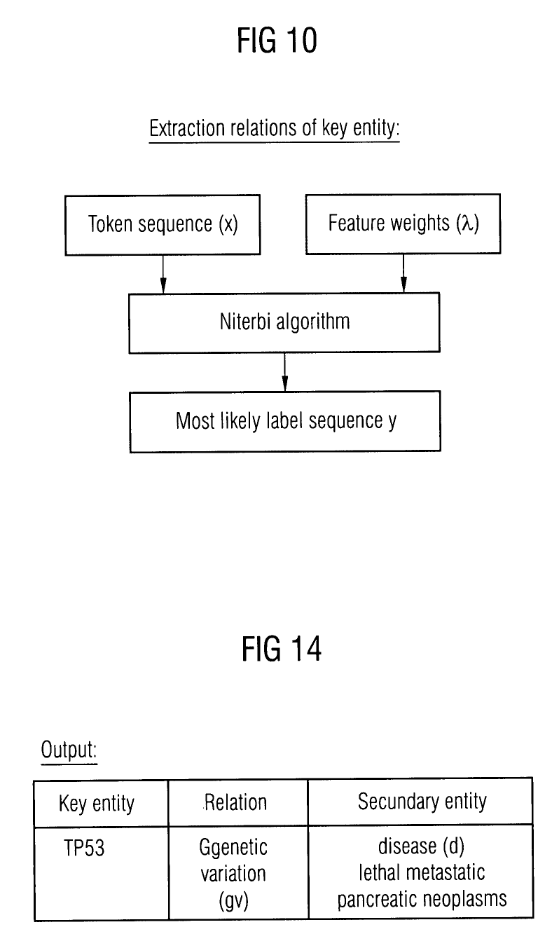

In a step S7 the token sequence of the input query Q is labeled by means of a Viterbi algorithm to find a most likely label sequence as shown in FIG. 10.

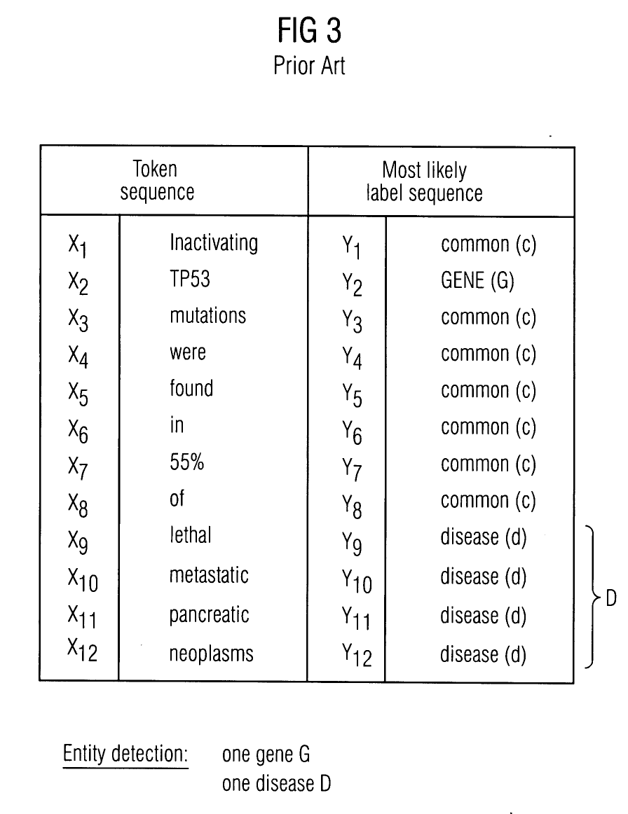

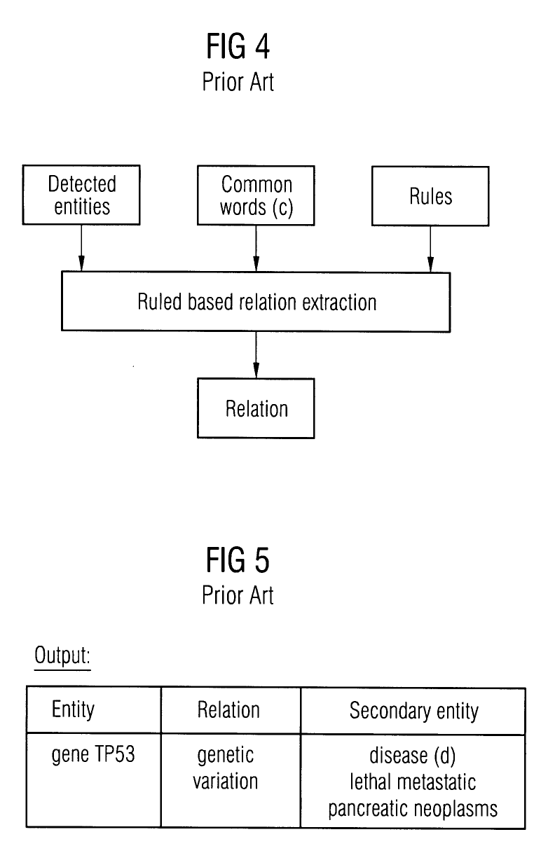

FIG. 13 shows a most likely label sequence generated by means of a Viterbi algorithm for the token sequence of the given example. By comparing FIG. 3 with FIG. 13 it becomes evident that with the method according to the present invention in step S7 a semantic relation of the key entity KE (in this case TP53) to other entities are directly extracted, i.e. in one single step. On the display 6 the user can see directly the relation between the key entity TP53 and secondary entities. In the given example the user is informed that there is a genetic variation as a relation between the key entity TP53 and the secondary entity “lethal metastatic pancreatic neoplasms”.

In the present invention the investigated text phrase refers to a key entity KE such as “TP53” so that all other entities in the text phrase state a kind of relation to the key entity KE.

For example, a biographical text usually gives information about an entity such as “Tony Blair” and all other entities in the text are involved in a certain relation with the entity (for example his family). Thus, with the present invention it is possible to predict a kind of relation holding between the key entity KE and all other secondary entities. With the method and system according to the present invention relation extraction is treated as a sequence labeling task. Accordingly, with the present invention a named entity recognition NER and a relation extraction step are merged together.

Accordingly, with the method and system according to the present invention the entities' label y encodes a relation to the key entity KE and there is no initial labeling of the named entities.

Gene RIF-sentences represent a similar style of text in the biomedical domain as biographical text. Gene RIF-sentences describe the function of a gene/protein, the key entity KE, as a concise phrase. As a consequence, gene RIF-sentences are an adequate source for transferring relation extraction to a sequence labeling problem.

For example, the following gene RIF sentence is linked to a gene COX-2:

“COX-2 expression is significantly more common in endometrical adenocarcinoma and ovarian serous cystadenocarcinoma, but not in cervical squamous carcinoma, compared with normal tissue.”

This sentence states three disease relations with COX-2 (the key entity), namely two altered expression relations (expression of COX-2 relates to endometrical adenocarcinoma and ovarian serous cystadenocarcinoma) and one unrelated relation (cervical squamous carcinoma).

Relation extraction RE is treated by the method according to the present invention as a tagging task such as NER or part of speech POS tagging. Accordingly, for each secondary entity the method of the present invention predicts the type of relation it has to the key entity KE. Each word in a sentence is regarded as a token x. Each token x is associated with a tag or label y which indicates the type of the token x. In the given example sentence about COX-2, the label “unrelated” is assigned to the tokens “cervical”, “squamous”, “carcinoma”, as they are evidently not related with the key entity gene whereas the tokens “endometrical”, “adenocarcinoma”, “ovarian”, “serous”, “cystadenocarcinoma” are labeled each as a disease related to the gene altered expression behaviour, thus, “altered expression”. These are the words representing diseases in the sentence. The other tokens x are labeled as not forming part of an entity. Two random variables X and Y are used to denote any input token sequences with associated label sequences. In the method according to the present invention to the given token sequence x₁, x₂, . . . , x, xₙ a correct label sequence y₁, Y₂, . . . yₙ is assigned.

The method of the relation extraction according to the present invention is based on a one-step probabilistic extraction model, such as a linear chain conditional random field CRF. The method according to the present invention extracts the relations. For example, the method according to the present invention extracts relations between genes and diseases from Gene RIF (Gene Reference Into Function) sentences. Gene RIF (Gene Reference Into Function) are sentences which refer to a particular gene in the Entrez gene data base and describe its function in a concise phrase. The semantic relations extracted by the method and system according to the present invention can comprise different relations such as “altered expression”, “other genetic variation”, “regulatory modification”, “a general relation” or “an existing relation” between two entities. For example gene-disease-relations are categorized based on whether a gene is causing a disease state is a predisposition factor or is just associated with the disease. In an embodiment of the method according to the present invention, the gene-disease-relation categories are based on the observed state of a gene or protein, e.g. transcription level or mutation associated with the disease state. A class for sentences reporting evidence of no association between a gene state and a disease and a neutral class given not specific observe state are provided.

The “altered expression” level of a gene/protein is reported to be associated with a certain disease or state of a disease. For example “low expression of BRCA-1 was associated with colorectal cancer”.

As a further semantic relation, the “genetic variation” relates to a mutational event which is reported to be related with a disease. For example, “Inactivating TP53 mutations were found in 55% of lethal metastatic pancreatic neoplasms”.

A further semantic relation “regulatory modification” states a modification of the gene/protein through methylation or phosphorylation. For example “e-cadherin and P16INK4A are commonly methylated in non-small cell lung cancer”.

The semantic relation “any” is given when relation between a gene and a disease is reported without any further information regarding the gene's state. For example: “e-cadherin has a role in preventing peritoneal dissemination in gastric cancer”.

As a further semantic relation, the relation “unrelated” indicates that a sentence is evident for an independence between a gene an a certain disease. For example “variations in TP53NBAX alleles are unrelated to the development of pemphigus foleaceus”. The method and system according to the present invention has in comparison to conventional methods a high recall, precision and f-score value.

On a manually annotated data set of gene RIFS, the recall, precision and f-score of the method and system according to the present invention are evaluated. The recall and precision depend of true positive TP, false negative TN and false positive FP as follows:

$$Recall = \frac{T P}{T P + F N}$$

$$Precision = \frac{T P}{T P + F P}$$

A true positive TP is a label sequence for a certain entity which exactly matches the label sequence for this entity from the standard. For example, in the following sentence “BRCA2 is mutated in stage II breast cancer” a human annotator labels “stage II breast cancer” as a disease related via genetic variation. Under the assumption that the method and system according to the present invention only recognizes “breast cancer” as a disease entity and categorizes the relation to gene-“BRCA2” as a “genetic variation”, the system gets assigned a false negative (FN) for not recognizing the whole sequence as well as one false positive (FP). In general, since this is hard matching criteria in many situations a more gentle criteria of correctness can be used.

Table 1 shows a text corpus statistics for an annotated data set of 5.469 gene RIFs.

TABLE 1

| | | | Altered | Genetic | Regulatory | |
|---|---|---|---|---|---|---|
| | Any | Unrelated | expression | variation | modification | All |
| Corpus | 1396 | 369 | 1750 | 1695 | 186 | 5369 |

Table 2 shows the results of a relation extraction RF as performed using the method and system according to the present invention.

TABLE 2

| | Recall | Precision | F-score |
|---|---|---|---|
| Any | 69.94 | 79.20 | 74.28 |
| Unrelated | 56.01 | 66.93 | 60-09 |
| Altered | 73.89 | 74.92 | 74.40 |
| expression | | | |
| Genetic | 75.99 | 778.06 | 77.01 |
| variation | | | |
| Regulatory | 61.13 | 70.50 | 65.48 |
| modification | | | |
| Overall | 71.54 | 76.31 | 73.84 |

Table 2 lists accuracy measures for each of the predefined regulation types. For any, altered expression and genetic variation relations the method and system according to the present invention exceeds a boundary 74 F-measure. Average over all relations types the method and system according to the present invention achieves an overall accuracy of 73.84 F-measure for the given data set.

Table 3 shows a comparison of different methods of semantic relation extraction. The first two models are based on a conventional two-step approach according to the state of the art consisting of an NER-step and a successive RE-step. In a first baseline model (dictionary plus rule-base) the NER-step is done via a dictionary longest matching approach while in the CRF plus rule-based model the NER-step is tackled via a disease NER CRF.

TABLE 3

| | Recall | Precision | F-score |
|---|---|---|---|
| Dictionary + rule- | 43.31 | 42.98 | 43.10 |
| based | | | |
| CRF + rule- | 67.62 | 71.88 | 69.68 |
| based | | | |
| Relation CRF | 71.54 | 76.31 | 73.84 |

As can be seen from table 3, the method and system according to the present invention clearly outperforms the conventional two baseline approaches. The difference between the two-step approach according to the prior art methods with disease CRF tagger plus additional successive rules for RE and the method according to the present invention is 4.16 F-measure. This result indicates that the unified CRF performed by the method according to the present invention is able to learn additional patterns from the empirical distribution which are important for inferring the type of relation holding between gene and disease pairs.

The method and system according to the present invention allows in a possible embodiment the identification of semantic gene disease relations based on a probabilistic extraction model. As can be seen from table 3, the overall performance of the method and system according to the present invention is better than conventional methods employing a two-step approach.

Since method and system according to the present invention is discussed mostly with respect to biomedical data it is emphasized that the method and system according to the present invention can be used for semantic relation extraction for any kind of unstructured text.

Further, the method and system according to the present invention can be used for semantic relation extraction for any unstructured text written in any language and any alphabet. The method and system according to the present invention allows to detect entities and their relations at the same time. The method and system according to the present invention has a higher performance, i.e. sensitivity and F-score, than conventional methods. The method and system according to the present invention do not only allow for a detection of a relation but also its characterization of its nature as far as mentioned in the unstructured text.

In a possible embodiment the method according to the present invention is performed by a computer program on a computer. A possible embodiment this computer program comprises instructions to perform the method and is stored on a data carrier.

1. A method for semantic relation extraction comprising: extracting directly on the basis of an annotated training corpus having tokens with associated relational labels each indicating a relation between the respective token and a selectable key entity semantic relation between said key entity and other entities from unstructured text using a probabilistic extraction model.

2. The method according to claim 1,
wherein the probabilistic extraction model is a conditional random field.

3. The method according to claim 1,
wherein weighting factors (λ) for each feature are calculated on the basis of a feature label distribution of said annotated training corpus by means of a maximum likelihood algorithm.

4. The method according to claim 1, wherein a query comprising said key entity is input by a user.

5. The method according to claim 4, wherein the input query is tokenized to generate a token sequence.

6. The method according to claim 5, wherein a most likely label sequence is calculated for the generated token sequence by means of a Viterbi algorithm using said calculated weighting factors.

7. The method according to claim 6, wherein a conditional probability (P) of the label sequence is calculated as follows:
$$p ( y / x ) = \frac{1}{{Z}_{x}} exp ( {\sum }_{i = 1}^{N} {\sum }_{k = 1}^{K} {λ}_{k} {f}_{k} ( {y}_{i - 1} , {y}_{i} , x , i )$$
wherein Zₓ is a normalization factor,
fₖ(yᵢ₋₁, yᵢ,x, i) is an arbitrary feature function, λ_{K} is a calculated weight factor for a feature function ranging between −∞ and +∞.

8. The method according to claim 7, wherein the normalization factor Zₓ is calculated as follows:
$${Z}_{x} = {\sum }_{s ∈ {S}^{N}} exp ( {\sum }_{i = 1}^{N} {\sum }_{k = 1}^{K} {λ}_{k} {f}_{k} ( {y}_{i - 1} , {y}_{i} , x , i )$$
wherein N is the length of the input sequence.

9. The method according to claim 1, wherein the semantic relations are formed by biomedical relations.

10. The method according to claim 9, wherein the biomedical relations is
an altered expression,
a genetic variation,
a regulatory modification,
a general relation, and
a non-existing relation between two entities.

11. The method according to claim 1, wherein a set of recognition features is provided.

12. The method according to claim 11, wherein the set of recognition features comprises:
orthographic features
word shape features,
n-gram features,
dictionary features, and
context features.

13. The method according to claim 1, wherein a set of relation recognition features is provided.

14. The method according to claim 13, wherein the set of relation recognition features comprises:
a dictionary window feature,
a key entity neighbourhood feature
a start window feature, and
a negation feature.

15. Method according to claim 1, wherein the entities are formed by biomedical entities.

16. The method according to claim 15, wherein the entities comprise genes, diseases, drugs, compounds and proteins.

17. A computer program for performing the method for semantic relation extraction according to claim 1.

18. A data carrier for storing instructions of a computer program which performs the method for semantic relation extraction according to claim 1.

19. A semantic relation extraction system comprising:
(a) means for storing unstructured text;
(b) means for storing an annotated training corpus having tokens with associated relational labels each indicating a relation between the respective token and a selectable key entity; and
(c) means for extracting semantic relations between the key entity and other entities from said unstructured text on the basis of said training corpus using a probabilistic extraction model.

20. The semantic relation extraction system according to claim 19, wherein said probabilistic extraction model is a conditional random field.
